(19) United States
(12) Patent Application Publication
(10) Pub. No.: US 2025/0388252 A1
(43) Pub. Date: Dec. 25, 2025

(54) Smartphone Holster For Shopping Carts

(71) Applicants: Ralph Peterson, Valencia, CA (US); Laura Peterson, Valencia, CA (US)

(72) Inventors: Ralph Peterson, Valencia, CA (US); Laura Peterson, Valencia, CA (US)

(21) Appl. No.: 18/748,322

(22) Filed: Jun. 20, 2024

(51) Int. Cl. B62B 3/14; F16M 13/02

(52) U.S. Cl. CPC B62B 3/1472; F16M 13/022

(57) ABSTRACT

A smartphone holster includes an adjustable support frame and a mounting clip. The support frame is designed to cradle and support a smartphone from below, wherein the support frame includes an expandable panel and a pair of L-shaped brackets projecting from the panel and designed to engage a pair of corners of a smartphone. The mounting clip is designed to removably attach to a rail of a shopping cart, wherein the mounting clip includes a first wall portion attached to the panel, a second wall portion positioned facing and apart from the first wall portion, and a curved portion connecting the first wall portion and the second wall portion and designed to fit around a rail of a shopping cart to suspend the support frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to smartphone holders and more particularly pertains to a new smartphone holster to hang or suspend a smartphone from a shopping cart, such as the rail of the infant or child seat portion near the front handle of the shopping cart to allow the user to review shopping lists and instructions on the smartphone screen during the shopping process.

### (2) Description of Related Art Including Information Disclosed Under 37 CFR 1.97 and 1.98

The prior art relates to smartphone holders. The prior art, as best understood, does not disclose a phone mounting device for shopping carts that is comprised of a plastic smartphone holding device with a resilient clip member disposed on the back surface which is used to removably secure the device to the frame of a shopping cart, where the device is used to cradle and display a smartphone.

### BRIEF SUMMARY OF THE INVENTION

An embodiment of the disclosure meets the needs presented above in a smartphone holster generally comprising an adjustable support frame and a mounting clip. The support frame is designed to cradle and support a smartphone from below, wherein the support frame includes an expandable panel and a pair of L-shaped brackets projecting from the panel and designed to engage a pair of corners of a smartphone. The mounting clip is designed to removably attach to a rail of a shopping cart, wherein the mounting clip includes a first wall portion attached to the panel, a second wall portion positioned facing and apart from the first wall portion, and a curved portion connecting the first wall portion and the second wall portion and designed to fit around a rail of a shopping cart to suspend the support frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a smartphone holster according to an embodiment of the disclosure.

FIG. 2 is a rear perspective view of an embodiment of the disclosure.

FIG. 3 is a side view of an embodiment of the disclosure.

FIG. 4 is a front view of an embodiment of the disclosure.

FIG. 5 is a top view of an embodiment of the disclosure.

FIG. 6 is a perspective view of an embodiment of the disclosure.

FIG. 7 is a perspective view of an embodiment of the disclosure in use.

FIG. 8 is a side view of an embodiment of the disclosure in use.

FIG. 9 is a perspective view of an embodiment of the disclosure.

FIG. 10 is a top view of an embodiment of the disclosure.

FIG. 11 is a close-up view of a portion of an embodiment of the disclosure.

### DETAILED DESCRIPTION OF THE INVENTION

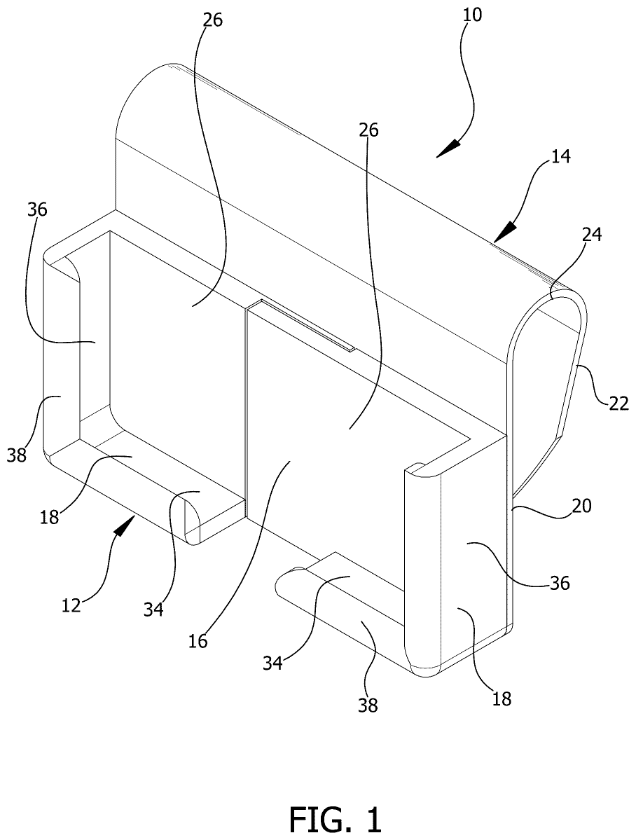

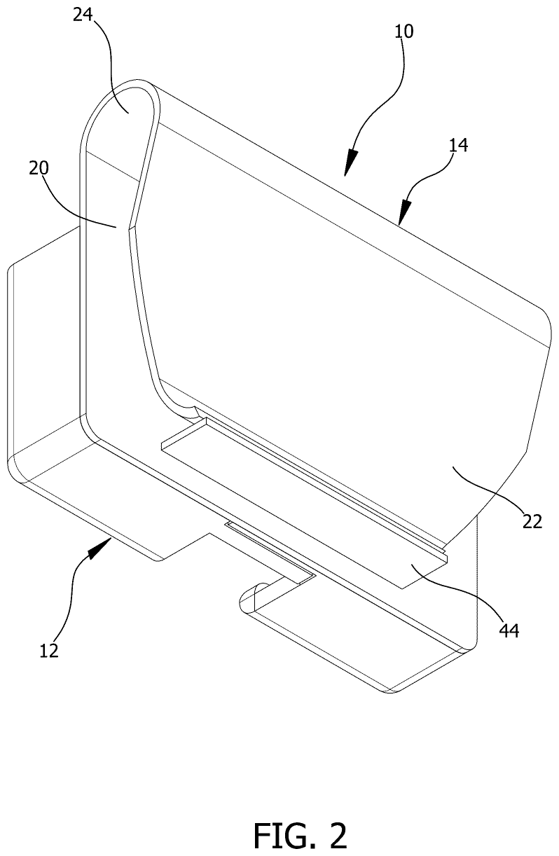

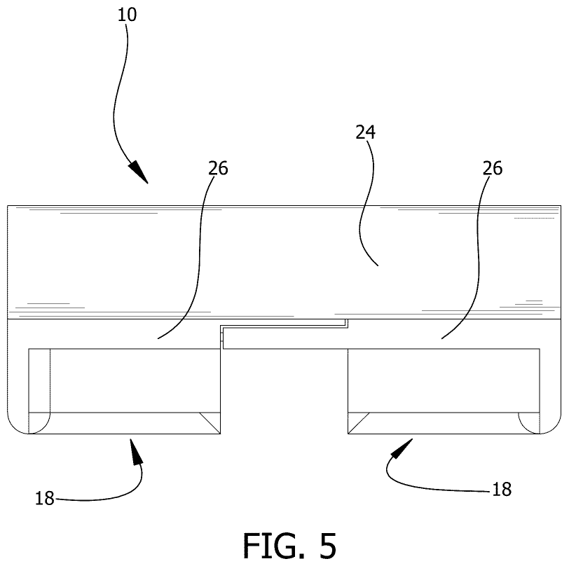

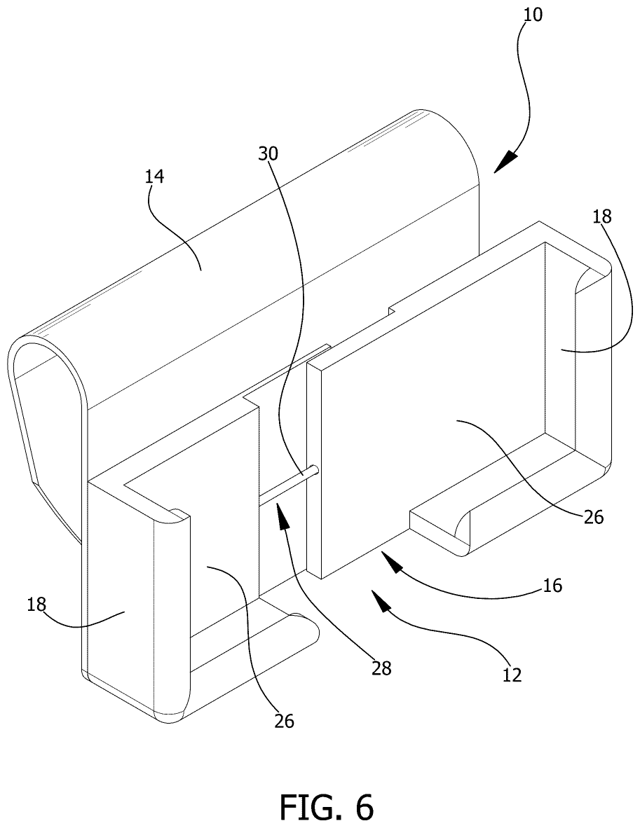

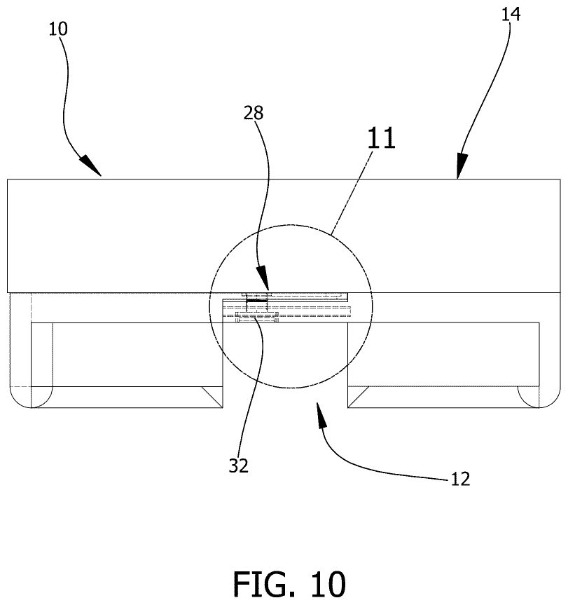

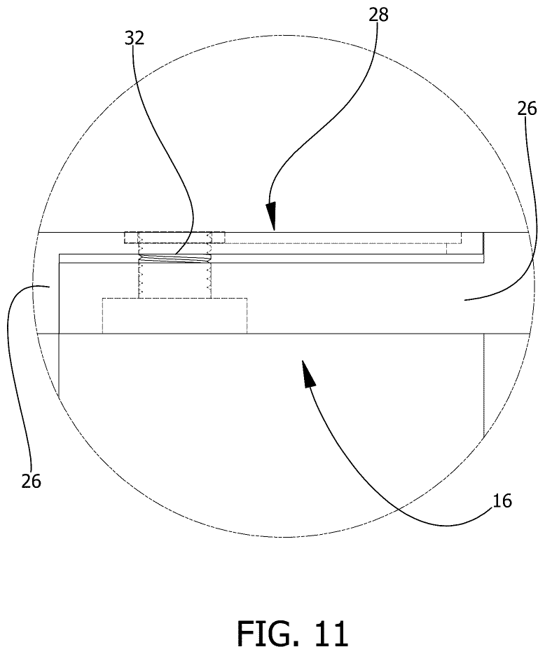

With reference now to the drawings, and in particular to FIGS. 1 through 11 thereof, a new smartphone holster embodying the principles and concepts of an embodiment of the disclosure and generally designated by the reference numeral 10 will be described.

As best illustrated in FIGS. 1 through 11, the smartphone holster 10 generally comprises an adjustable support frame 12 and a mounting clip 14. The support frame 12 is designed to cradle and support a smartphone 70 from below, wherein the support frame 12 includes an expandable panel 16 and a pair of L-shaped brackets 18 projecting from the panel 16 and designed to engage a pair of corners of a smartphone 70. The mounting clip 14 is designed to removably attach to a rail of a shopping cart 72, wherein the mounting clip 14 includes a first wall portion 20 attached to the panel 16, a second wall portion 22 positioned facing and apart from the first wall portion 20, and a curved portion 24 connecting the first wall portion 20 and the second wall portion 22 and designed to fit around a rail of a shopping cart 72 to suspend the support frame 12.

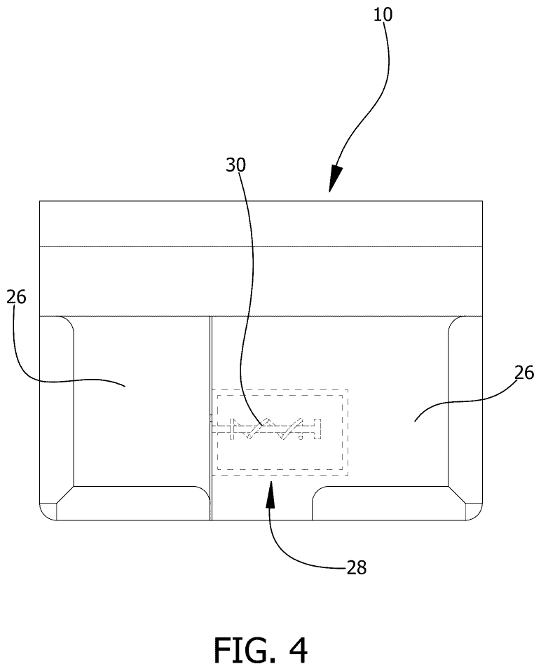

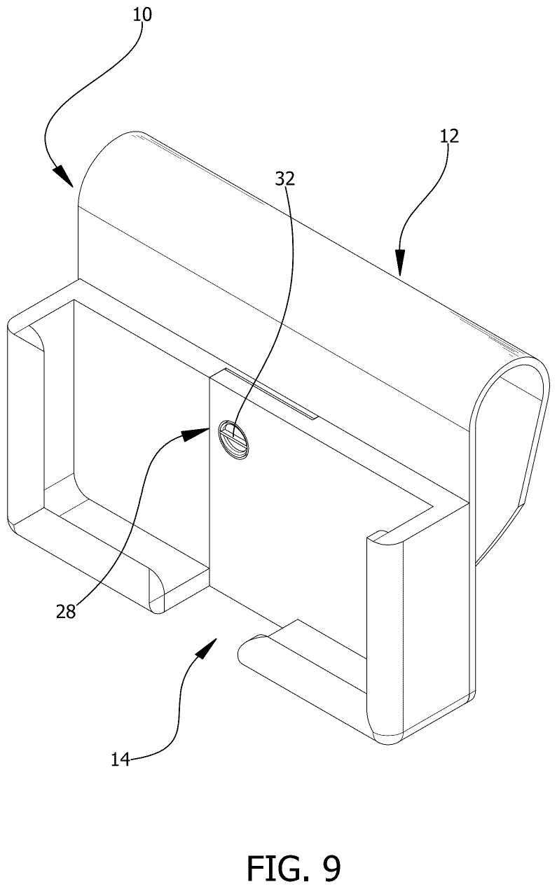

The panel 16 includes two panel sections 26 connected by an adjustment mechanism 28 designed to permit relative movement of the two panel sections 26 to increase and decrease the width of the panel 16 and the distance between the brackets 18. As shown in FIG. 4, the adjustment mechanism 28 includes a spring-loaded linkage 30 designed to bias the two panel sections 26 together. In another possible embodiment shown in FIGS. 9 through 11, the adjustment mechanism 28 includes a locking screw 32 to releasably lock the panel sections 26 together at a desired width of the panel 16.

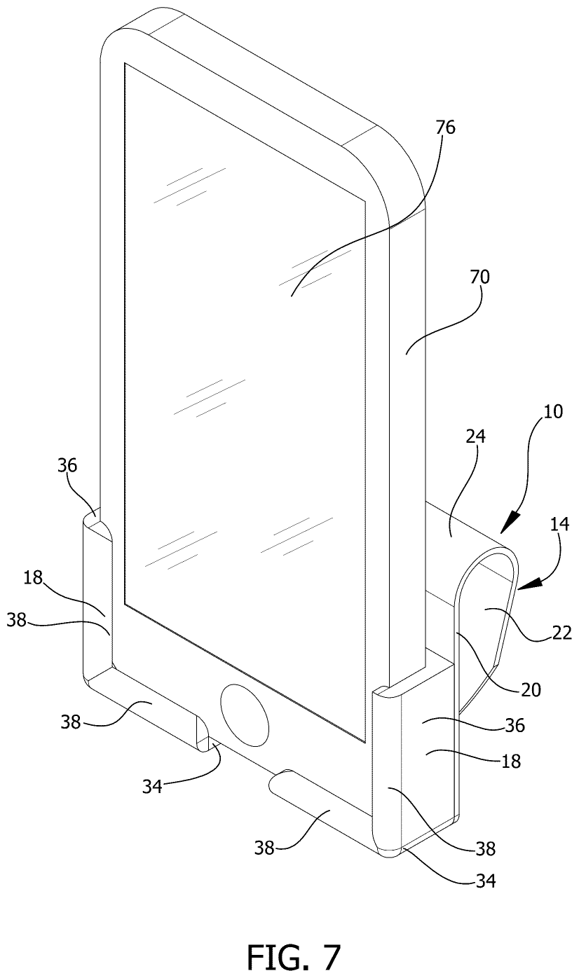

As best seen in FIG. 1, each of the brackets 18 includes a bottom portion 34 and a side portion 36 projecting perpendicular to the panel 16. The bottom portion 34 supports a smartphone 70 thereon and the side portion 36 engages a side edge of a smartphone 70, as best seen in FIG. 7. It should be noted that FIG. 7 shows the smartphone 70 in an upright or portrait-style orientation, though in one possible embodiment the smartphone 70 could be supported on its side or in a landscape-style orientation. Each of the brackets 18 also includes a retaining lip 38 extending parallel to the panel 16 and designed to engage a front face of a smartphone 70.

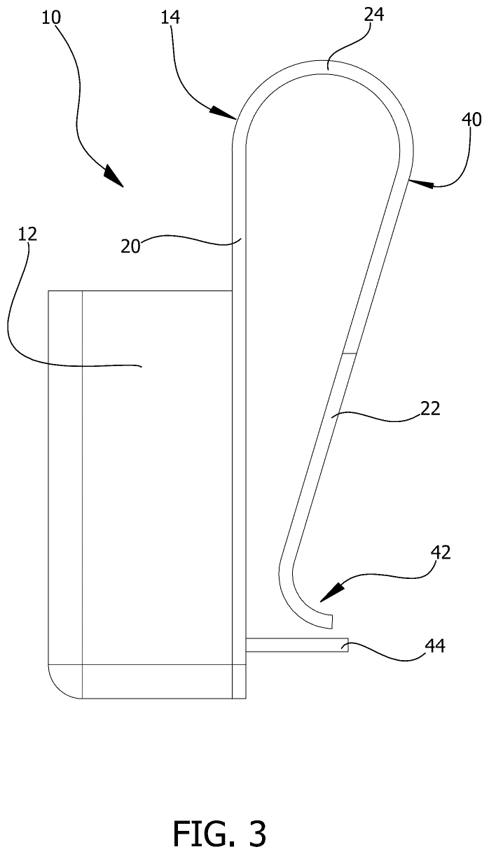

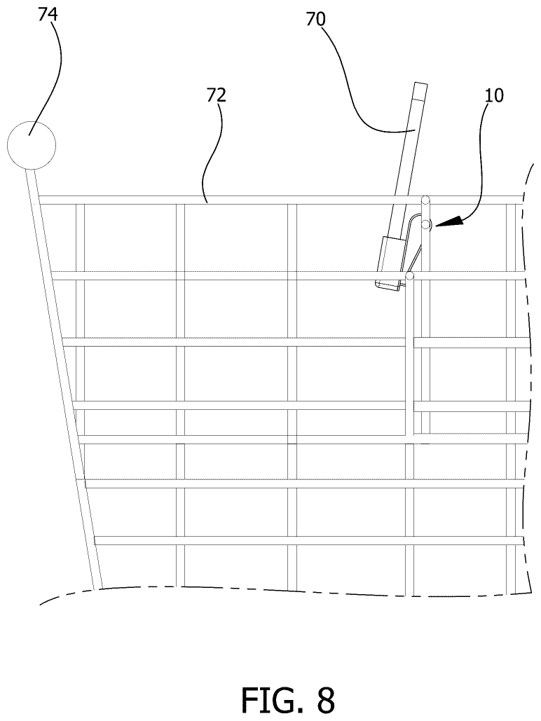

As shown in FIG. 3, the second wall portion 22 is angled inwardly toward the first wall portion 20 such that the distance between a first end section 40 connected to the curved portion 24 and the first wall portion 20 and is greater than the distance between a distal second end section 42 and the first wall portion 20. The curved portion 24 is resiliently flexible to permit the second wall portion 22 to be temporarily displaced from the first wall portion 20 during placement of the mounting clip 14 on a rail of a shopping cart 72. In the exemplary embodiment shown in FIG. 3, the second end section 42 is curved outwardly away from the first wall portion 20. The mounting clip 14 can also include a support member 44 projecting from the first wall portion 20 adjacent the second end section 42. As best seen in FIG. 8, the support member 44 is designed to brace against a frame portion of a shopping cart 72 to prop the support frame 12 at an angle to permit better viewing of a screen of a smartphone 70.

The smartphone holster 10 is primarily used to hang or suspend a smartphone 70 from a shopping cart 72, such as the rail of the infant or child seat portion near the front handle 74 of the shopping cart 72, though the smartphone holster 10 could be used on other wire frames. The smartphone holster 10 is especially useful for users who are personal shoppers or similar to allow the user to review shopping lists and instructions during the shopping process. As shown in FIG. 8, to install the smartphone holster 10, the user slides the mounting clip 14 over a rail of a shopping cart 72. The user can expand the panel 16 and place two corners of the smartphone 70 in the brackets 18, as shown in FIG. 7, such that a screen 76 of the smartphone 70 faces toward a person pushing the shopping cart 72, as shown in FIG. 8. The user then uses the shopping cart 72 while viewing the screen 76 of the smartphone 70.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A smartphone holster comprising:
an adjustable support frame configured to cradle and support a smartphone from below, wherein said support frame comprises an expandable panel and a pair of L-shaped brackets projecting from said panel and configured to engage a pair of corners of a smartphone; and
a mounting clip configured to removably attach to a rail of a shopping cart, wherein said mounting clip comprises a first wall portion attached to said panel, a second wall portion disposed facing and apart from said first wall portion, and a curved portion connecting said first wall portion and said second wall portion and configured to fit around a rail of a shopping cart to suspend said support frame.

2. The smartphone holster of claim 1, wherein said panel comprises two panel sections connected by an adjustment mechanism configured to permit relative movement of said two panel sections to increase and decrease the width of said panel and the distance between said brackets.

3. The smartphone holster of claim 2, wherein said adjustment mechanism comprises a spring-loaded linkage configured to bias said two panel sections together.

4. The smartphone holster of claim 2, wherein said adjustment mechanism comprises a locking screw to releasably lock said panel sections together at a desired width of said panel.

5. The smartphone holster of claim 1, wherein each of said brackets comprises a bottom portion and a side portion projecting perpendicular to said panel, wherein said bottom portion supports a smartphone thereon and said side portion engages a side edge of a smartphone.

6. The smartphone holster of claim 1, wherein each of said brackets comprises a retaining lip extending parallel to said panel and configured to engage a front face of a smartphone.

7. The smartphone holster of claim 1, wherein said second wall portion is angled inwardly toward said first wall portion such that the distance between a first end section connected to said curved portion and said first wall portion and is greater than the distance between a distal second end section and said first wall portion.

8. The smartphone holster of claim 7, wherein said curved portion is resiliently flexible to permit said second wall portion to be temporarily displaced from said first wall portion during placement of said mounting clip on a rail of a shopping cart.

9. The smartphone holster of claim 8, wherein said second end section is curved outwardly away from said first wall portion.

10. The smartphone holster of claim 1, wherein said mounting clip comprises a support member projecting from said first wall portion adjacent said second end section and configured to brace against a frame portion of a shopping cart to prop said support frame at an angle to permit better viewing of a screen of a smartphone.

11. A method of using the smartphone holster of claim 1, comprising the steps of:
sliding said mounting clip over a rail of a shopping cart;
expanding said panel and placing a pair of corners of a smartphone in said brackets, such that a screen of said smartphone faces toward a person pushing said shopping cart; and
using said shopping cart while viewing said screen of said smartphone.

12. A smartphone holster comprising:
an adjustable support frame configured to cradle and support a smartphone from below, wherein said support frame comprises an expandable panel and a pair of L-shaped brackets projecting from said panel and configured to engage a pair of corners of a smartphone, wherein:
said panel comprises two panel sections connected by an adjustment mechanism configured to permit relative movement of said two panel sections to increase and decrease the width of said panel and the distance between said brackets, wherein:
said adjustment mechanism comprises a spring-loaded linkage configured to bias said two panel sections together,
said adjustment mechanism comprises a locking screw to releasably lock said panel sections together at a desired width of said panel,
each of said brackets comprises a bottom portion and a side portion projecting perpendicular to said panel, wherein said bottom portion supports a smartphone thereon and said side portion engages a side edge of a smartphone,
each of said brackets comprises a retaining lip extending parallel to said panel and configured to engage a front face of a smartphone; and
a mounting clip configured to removably attach to a rail of a shopping cart, wherein said mounting clip comprises a first wall portion attached to said panel, a second wall portion disposed facing and apart from said first wall portion, and a curved portion connecting said first wall portion and said second wall portion and configured to fit around a rail of a shopping cart to suspend said support frame, wherein:
said second wall portion is angled inwardly toward said first wall portion such that the distance between a first end section connected to said curved portion and said first wall portion and is greater than the distance between a distal second end section and said first wall portion,
said curved portion is resiliently flexible to permit said second wall portion to be temporarily displaced from said first wall portion during placement of said mounting clip on a rail of a shopping cart,
said second end section is curved outwardly away from said first wall portion,
said mounting clip comprises a support member projecting from said first wall portion adjacent said second end section and configured to brace against a frame portion of a shopping cart to prop said support frame at an angle to permit better viewing of a screen of a smartphone.
